(19) United States
(12) Patent Application Publication
(10) Pub. No.: US 2008/0007780 A1
(43) Pub. Date: Jan. 10, 2008

(54) Printing system, printing control method, and computer readable medium

(76) Inventor: Fujio Ihara, Ashigarakami-gun (JP)

Correspondence Address: GAUTHIER & CONNORS;Suite 2300, 225 Franklin Street, Boston, MA, 02110, US

(21) Appl. No.: 11/546,834

(22) Filed: Oct. 12, 2006

(30) Foreign Application Priority Data
Jun. 28, 2006 (JP) 2006-178481

(51) Int. Cl. G06K 15/00

(52) U.S. Cl. 358/1.16

(57) ABSTRACT

There is provided a printing system including a receiving unit that receives from a computer document data to be used for printing in a printer, a storage unit that stores document data received by the receiving unit at least until the document data are used for printing in the printer, a monitoring unit that monitors a processing condition of the printer, and a deleting unit that deletes document data stored in the storage unit when the monitoring unit detects that the printer enters an anomalous condition.

### BACKGROUND

1. Technical Field

The present invention relates to data security in a storage device for temporarily storing data of an image to be printed.

2. Related Art

With the recent growth in network technology and cryptographic technology, research and development for realizing electronic government services have become more serious. A certificate issuance service is such that an applicant who wishes to obtain a certificate applies for issuance of an official certificate such as a resident register via a terminal located at home or in a community center, post office, convenience store, or the like, and an issuance server receives the application, generates certificate data, and transmits the data to a printer located at a desired site of the applicant or a predetermined site to allow the applicant to print out the certificate.

In order to promptly receive a print request from the issuance server, a typical network-connected printer used in such a service temporarily stores the print data sent from the issuance server in a buffer area, called a spool area, which is secured in a unit normally composed of a hard disk or the like. Then, when the print data become ready for printing, the printer carries out printing in the received order of print requests.

### SUMMARY

According to an aspect of the present invention, there is provided a printing system including a receiving unit that receives from a computer document data to be used for printing in a printer, a storage unit that stores document data received by the receiving unit at least until the document data are used for printing in the printer, a monitoring unit that monitors a processing condition of the printer, and a deleting unit that deletes document data stored in the storage unit when the monitoring unit detects that the printer enters an anomalous condition.

### BRIEF DESCRIPTION OF THE DRAWINGS

An exemplary embodiment of the present invention will be described in detail based on the following figures, wherein:

FIG. 1 is a view showing an example of a document issuance system to which an exemplary embodiment is applied;

FIG. 2 is a view showing an example of the inner structure of a printer in the system according to an exemplary embodiment;

FIG. 3 is a view showing an example of a management table of document data to be printed in a printer;

FIG. 4 is a view showing a processing flow in the system according to an exemplary embodiment; and

FIG. 5 is a view showing an example of a hardware configuration of a computer.

### DETAILED DESCRIPTION

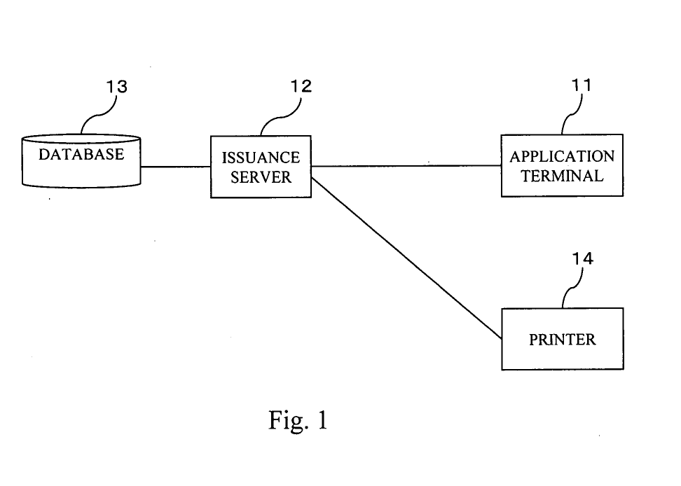

An example of a system to which an exemplary embodiment may be applied is described hereinafter with reference to FIG. 1. The system of FIG. 1 includes an application terminal 11, an issuance server 12, a database 13 of the issuance server 12, and a printer 14, all of which are interconnected through a data communication network such as the Internet or a LAN (Local Area Network), a communication cable, or the like.

The application terminal 11 is a terminal which may be used by an applicant to apply for the issuance of a resident register or the like. The application terminal 11 may be a computer such as a personal computer, into which software for official document issuance application is installed. The application terminal 11 may be located in a public place such as a community center, a post office, or a convenience store. A personal computer of each user can also serve as the application terminal 11 if software for official document issuance application is installed therein. The applicant who wishes to request the official document issuance service uses the application terminal 11 to submit an application to the issuance server 12.

In application processing, an applicant inputs to the application terminal 11 user information such as a user ID and a password which enables identification of the applicant, and also inputs a type of a requested document (e.g. resident register) and the number of copies. The user information may be entered by way of manual input by the applicant using an input device such as a keyboard or a touch panel attached to the application terminal 11, or by way of reading a token such as an IC card held by the applicant using a reader attached to the application terminal 11. The input information is transmitted as application information to the issuance server 12.

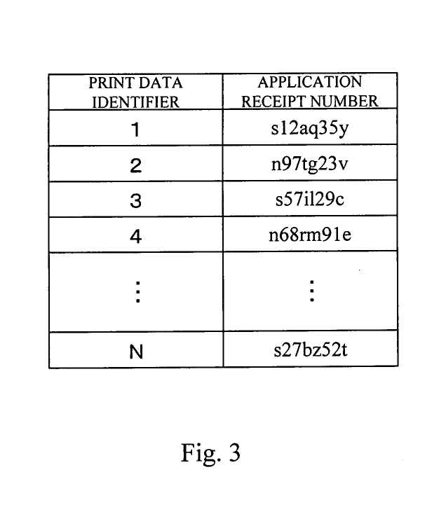

The issuance server 12 performs document issuance processing on the basis of the application information sent from the application terminal 11. For example, the issuance server 12 creates an electronic document (document data) of a requested document such as a resident register and generates a unique application receipt number corresponding to the electronic document. The issuance server 12 then associates the electronic document and the application receipt number corresponding thereto with a user ID for identifying the applicant and stores them into the database 13. The application receipt number generated at this time may contain information about a confidentiality level of the electronic document to be issued. Because the document issued by the issuance server 12 is not always confidential, the application receipt number may be such that it can distinguish between a confidential document (that is, a document which requires protection of document data temporarily stored in a spool area of the printer 14) and a non-confidential document. In an example illustrated in FIG. 3, an application receipt number of a confidential document begins with the letter “s,” and that of a non-confidential document begins with the letter “n.” Such a manner of distinguishing is merely one example, and the application receipt number may take any form to distinguish between confidential and non-confidential. The generated application receipt number is sent back to the application terminal 11 from which the application has been sent. The applicant stores this application receipt number or saves it in a token such as an IC card for later use.

Instead of using the application receipt number, whether or not document data should be confidential may be identified on the basis of information which is previously added to the document data to indicate the presence or absence of confidentiality.

The printer 14 is used to print out an issued document, and may be located in a public place such as a community center, a post office, or a convenience store, or at the applicant's home, as in the case of the application terminal 11. The printer 14 has a UI (user interface) function for receiving a print request from an applicant. The printer 14 may be a single unit which has both a UI function and a printing function, or a system in which a printer for printing data on a print medium and a computer such as a personal computer for controlling the printer are connected through a network or a cable. The printer 14 placed at the applicant's home is often the latter. The printer 14 may also function as the application terminal 11.

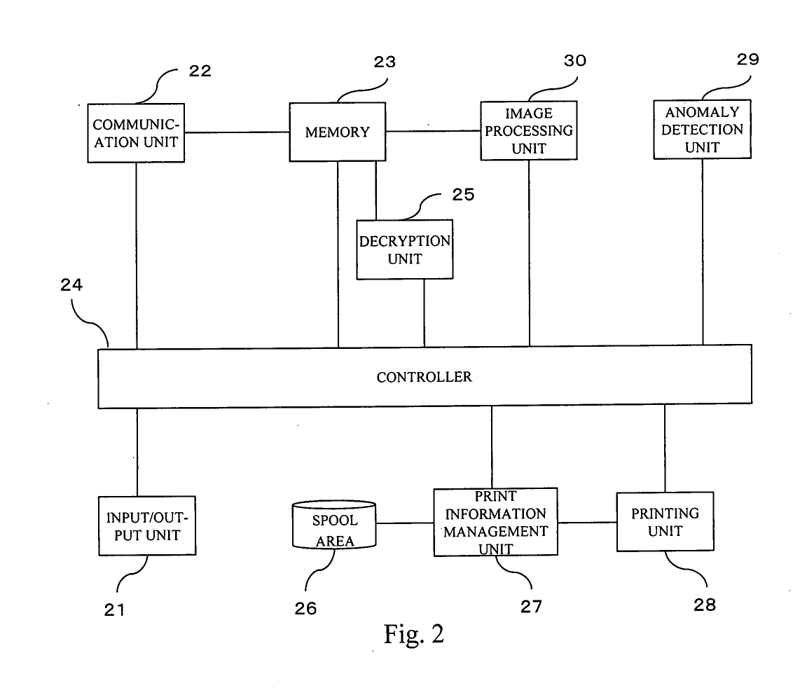

The functional structure of the printer 14 is described in detail hereinafter with reference to FIG. 2. An input/output unit 21 is a functional module to serve as a UI. The UI function can be implemented by the combination of an input device such as a keyboard and a display device such as a liquid crystal display. It can also be implemented by a device having both an input function and a display function, such as a touch panel. Further, the UI function can be implemented by a reader device for reading a token such as an IC card which stores user information of an applicant and/or an application receipt number. A communication unit 22 provides a function for communication with the issuance server 12 or another computer through a network such as a LAN or the Internet. A memory 23 is a working memory used by a controller 24 of the printer 14, and it may be implemented by a semiconductor RAM (Random Access Memory). The memory 23 is used for temporarily storing the data received from the issuance server 12 or another computer through a network, loading an operation program of the printer 14, or as a temporary work area for various calculations. A decryption unit 25 decrypts the document data to be printed which are transmitted through a network, if they are encrypted.

A spool area 26 is a buffer area for storing the document data transmitted through network temporarily at least until they are printed. The spool area 26 may be a nonvolatile memory such as a hard disk drive.

If the printer 14 is a system which is composed of a personal computer and a printer connected thereto, the printer provides the functions of a printing unit 28 (and sensors of an anomaly detection unit 29), and the personal computer or its accessory provides other functions (e.g. the input/output unit 21 or the spool area 26).

A print information management unit 27 is a functional module for managing the execution of a printing job. The print information management unit 27 manages the requested printing job in a data structure of queue and supplies an image of the document to be printed by turns to the printing unit 28 to thereby execute printing. The printing unit 28 receives the image data of the document and prints the image data on a print medium.

Specifically, for example, the print information management unit 27 stores the document data received through a network into the spool area 26 (if the received document data are encrypted, decrypted data may be stored in the area 26). Then, the print information management unit 27 allocates a unique print data identifier to the document data stored in the spool area and registers the print data identifier in a management table by associating the identifier with the application receipt number transmitted from the issuance server 12 in association with the document data. FIG. 3 illustrates an example of data contents of the management table. The management table is an example of a print job queue. The print information management unit 27 supplies each set of document data registered in the management table sequentially to the printing unit 28 to print it out. If the printing of the document data ends normally, the print information management unit 27 deletes the document data from the spool area 26 and also deletes the entry corresponding to the document data from the management table. Further, the print information management unit 27 deletes the print data in the spool area in response to anomaly notification from the anomaly detection unit 29 (data deletion based on anomaly detection is detailed later).

If the document data in the spool area 26 are described in page description language, an image processing unit 30 interprets rendering instruction and generates image data (e.g. raster image data) which can be processed by the printing unit 28. If the document data are compressed and coded data such as JPEG (Joint Photographic Experts Group), the image processing unit 30 decodes the data to generate the image data which can be processed by the printing unit 28. On the thus-generated image data, the image processing unit 30 performs image processing such as color conversion in accordance with the characteristics of the printing unit 28. The print raster image data which can be printed on a print medium are thereby generated.

The anomaly detection unit 29 monitors the condition of the printing unit 28 to detect the occurrence of a particular anomalous condition such as interruption of printing in the printing unit 28. Such an anomalous condition may include paper jam, paper-out (out of necessary print medium in a paper feed section), open/close of a paper feed section, out of ink or toner, and so on. Sensors are placed in the printing unit 28 for detecting the various conductions, and the anomaly detection unit 29 detects the presence or absence of such a particular anomalous condition on the basis of signals from those sensors. When detecting such an anomalous condition, the anomalous detection unit 29 notifies the occurrence of the anomalous condition to the controller 24.

If a printer is such that it takes some time between turn-off of a main switch (power switch) of the printer 14 and shutdown of power supply to each section of the printer 14, the detection items of the anomaly condition detection unit 29 may further include the turn-off of a main switch. If the printer 14 is a system which is composed of a personal computer and a printing device connected to the computer, the document data in the spool area 26 of the personal computer are normally saved even if the printing device is powered off. Thus, turn-off or power-off of the main switch of the printing device may be added to the anomalous conditions to be detected by the anomaly detection unit 29.

The controller 24 controls the overall operation of the printer 14. The controller 24 receives an issuance request from an applicant through the input/output unit 21 and makes a request for issuance to the issuance server 12 through the communication unit 22. When the controller 24 receives document data from the issuance server 12 in response to the issuance request, it stores the data into the spool area 26 and registers the document data in the print information management unit 27. If the document data are encrypted, it decrypts the document data by means of the decryption unit 25 and registers the decrypted document data. When there are no document data being printed and no notification for an anomalous condition from the anomaly detection unit 29, the controller 24 sends the document data in the spool area 26 to the image processing unit 30 sequentially from the data set which is stored first to start printing. After the printing is completed, the controller 24 deletes the print data from the spool area 26 and sends a print completion flag and the application receipt number to the issuance server 12. The controller 24 also instructs the print information management unit 27 to update the management table.

When there is a notification for the occurrence of an anomalous condition from the anomaly detection unit 29, the controller 24 deletes the document data in the spool area 26. If it is possible to distinguish whether or not the document data to be printed which are received from the issuance server 12 are confidential on the basis of the associated application receipt number, only the confidential document data in the spool area 26 may be selectively deleted. At this time, the controller 24 may request resending to the issuance server 12 of the deleted document data by sending the application receipt number of the deleted document data together with a resend flag. Further, if it is in the process of printing data on a print medium upon receipt of notification for the occurrence of an anomalous condition from the anomaly detection unit 29, the controller 24 may not only delete the document data from the spool area 26 but also supply to the printing unit 28 different information from the document data being printed so as to stop the printing on the current print medium and output it in such a state that the middle to end part of the print medium is blank or to fill the middle to end part of the print medium with a certain color such as black, for example.

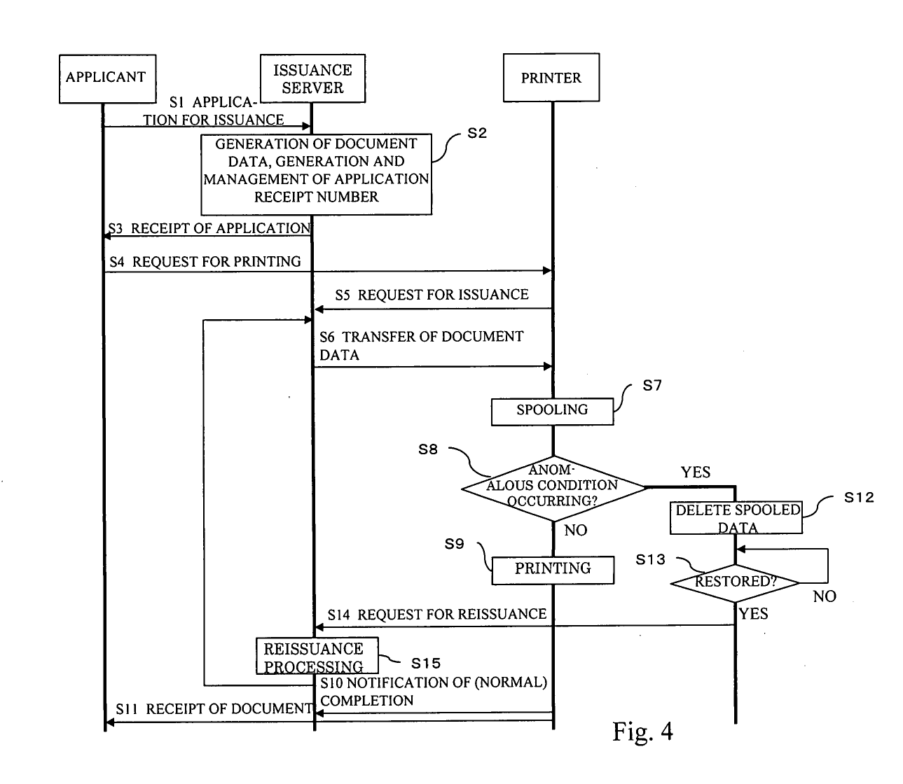

With reference to FIG. 4, a process flow from the start of issuance application to the receipt of an issued document by an applicant is described.

The applicant inputs user information such as user ID to the application terminal 11 to receive user authentication from the issuance server 12. If the applicant is authenticated as a valid user, the applicant then inputs to the issuance server 12 a type of a document for which issuance is requested, the number of copies of the document, and so on through a UI screen to apply for the issuance (S1). The issuance server 12 then generates document data corresponding to the requested document and also generates a unique application receipt number for the requested document. The issuance server 12 registers into the database 13 the application receipt number in association with the document data (S2) and returns the application receipt number to the applicant (application terminal 11) (S3).

Upon receiving the application receipt number, the applicant inputs the user information and the application receipt number through the UI of the printer 14 which is located in a prescribed place and makes a print request (S4). Upon receipt of the print request, the printer 14 transmits to the issuance server 12 an issuance request containing the user information and the application receipt number (S5). Upon receiving the issuance request, the issuance server 12 retrieves from the database 13 the document data corresponding to the application receipt number contained in the request and transmits the retrieved document data and the application receipt number to the printer 14 (S6).

Upon receipt of the document data and the application receipt number from the issuance server 12, the printer 14 stores the document data into the spool area 26 and updates the management table of the print information management unit 27 accordingly (S7: Spooling).

The anomaly detection unit 29 of the printer 14 monitors whether a particular anomalous conduction occurs in the printing unit 28 (S8) If the anomaly detection unit 29 does not detect any anomalous conduction in the printing unit 28, the controller 24 executes processing for printing the document data stored in the spool area 26 in order of receipt (S9). When the printing of one document data ends normally, the controller 24 sends to the issuance server 12 the application receipt number and information indicating normal completion of printing, deletes the document data from the spool area 26, and updates the management table of the print information management unit 27 by deleting the entry of the document data, for example (S10). The applicant thereby receives the requested document (S11).

On the other hand, if the anomaly detection unit 29 detects a particular anomalous condition occurring in the printing unit 28, the controller 24 deletes the document data stored in the spool area 26 (or selectively deletes the confidential document data) (S12). Then, the controller 24 monitors the condition of the printing unit 28 through the anomaly detection unit 29 or the like (S13). If the monitoring detects that the anomalous condition detected in Step S8 is eliminated and the printing unit 28 has returned to the normal operable state, the controller 24 sends to the issuance server 12 a resend request containing the application receipt number of the document data which are deleted in Step S12 (S14).

Upon receiving the resend request, the issuance server 12 retrieves from the database 13 the document data corresponding to the application receipt number contained in the resend request (S15) and resends the retrieved document data to the printer 14 (S6). Upon receipt of the resent document data, the printer 14 spools the data (S7) and executes the same management as above.

In the above-described example, the printer reacquires from the issuance server 12 the document data which have been deleted from the spool area 26 in response to the occurrence of an anomalous condition in the printing unit 28 after the printing unit 28 is restored from the anomalous condition (S14). Instead of such an automatic reacquisition, it is possible to give notification to an applicant by way of display a message on a UI of the printer 14 when the document data is deleted from the spool area 26 prompting the applicant to submit a print request again.

Although the above description is directed to a system for issuing official documents such as electronic government services, the control of the printer 14 in the above exemplary embodiment may be applied to the control of the printing of any documents, not limited to an official document, where fraud on the document data stored in the spool area 26 should be prevented.

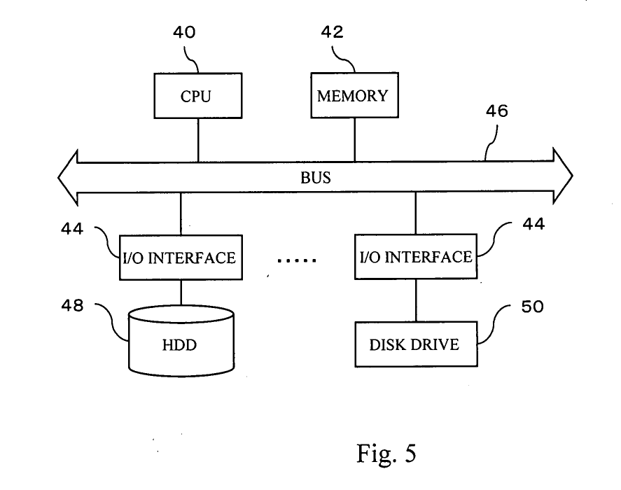

The control of the spool area 26 or the like in the printer 14 described above can be implemented by executing a program which describes the functions or processing contents of each unit on a computer. As shown in FIG. 5, the computer may have a circuit configuration as hardware in which a CPU (Central Processing Unit) 40, a memory (primary storage) 42, I/O (Input/Output) interfaces 44, and so on are connected through a bus 46. Through the bus 46, there may be connected a hard disk drive 48 and a disk drive 50 for reading a portable nonvolatile recording medium of various standards such as CD, DVD, or flash memory. Such drives 48 and 50 serve as external memory storage devices. The program which contains the description of the processing of the exemplary embodiment is saved on a secondary storage device such as the hard disk drive 48 or other types of nonvolatile recording devices through a recording medium such as CD or DVD or through a network and then installed in the computer. The program stored in the secondary storage device is loaded to a memory and executed by the CPU, thereby implementing the processing of the exemplary embodiment.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A printing system comprising:
a receiving unit that receives, from a computer, document data to be used for printing in a printer;
a storage unit that stores the document data received by the receiving unit at least until the document data are used for printing in the printer;
a monitoring unit that monitors a processing condition of the printer; and
a deleting unit that deletes the document data stored in the storage unit when the monitoring unit detects that the printer enters an anomalous condition.

2. The printing system according to claim 1, further comprising:
a reacquiring unit that, if the deleting unit deletes the document data in the storage unit, reacquires the deleted document data from the computer after the printer is restored from the anomalous condition.

3. The printing system according to claim 1, wherein the document data is associated with accompanying information used for determining whether or not protection is needed, and
the deleting unit deletes protective document data determined to require protection by the accompanying information selected from the document data stored in the storage unit.

4. The printing system according to claim 1, further comprising:
a supplying unit that, if the printer is in the process of printing document data on a print medium when the monitoring unit detects that the printer enters the anomalous condition, supplies different information to the printer such that the different information from the document data used in the process of printing is printed on the print medium.

5. A printing control method comprising:
receiving, from a computer, document data to be used for printing in a printer;
storing received document data in a storage unit at least until the document data are used for printing in the printer;
monitoring a processing condition of the printer; and
deleting document data stored in the storage unit when the monitoring detects that the printer enters an anomalous condition.

6. The printing control method according to claim 5, further comprising:
if document data in the storage unit are deleted, reacquiring the deleted document data from the computer after the printer is restored from an anomalous condition.

7. The printing control method according to claim 5, wherein
the document data are associated with accompanying information used for determining whether or not protection is needed, and
the deleting process comprises deleting document data determined to require protection by the accompanying information selected from the document data stored in the storage unit.

8. The printing control method according to claim 5, further comprising:
if the printer is in the process of printing document data on a print media when the monitoring detects that the printer enters an anomalous condition, supplying different information to the printer such that different information from the document data used in the process of printing is printed on the print medium.

9. A computer readable medium storing a program causing a computer to execute a process for printing control, the process comprising:
receiving from a computer document data to be used for printing in a printer;
storing received document data in a storage unit at least until the document data are used for printing in the printer;
monitoring a processing condition of the printer; and
deleting document data stored in the storage unit when the monitoring detects that the printer enters an anomalous condition.

10. The computer readable medium according to claim 9, further comprising:
if document data in the storage unit are deleted, reacquiring the deleted document data from the computer after the printer is restored from an anomalous condition.

11. The computer readable medium according to claim 9, wherein
the document data are associated with accompanying information used for determining whether or not protection is needed, and
the deleting comprises deleting document data determined to require protection is by the accompanying information selected from the document data stored in the storage unit.

12. The computer readable medium according to claim 9, further comprising:
if the printer is in the process of printing document data on a print media when the monitoring detects that the printer enters an anomalous condition, supplying different information to the printer such that different information from the document data used in the process of printing is printed on the print medium.

13. A computer data signal embodied in a carrier wave for enabling a computer to perform a process for printing control, the process comprising:
receiving from a computer document data to be used for printing in a printer;
storing received document data in a storage unit at least until the document data are used for printing in the printer;
monitoring a processing condition of the printer; and
deleting document data stored in the storage unit when the monitoring detects that the printer enters an anomalous condition.

14. The computer data signal according to claim 13, further comprising:
if document data in the storage unit are deleted, reacquiring the deleted document data from the computer after the printer is restored from an anomalous condition.

15. The computer data signal according to claim 13, wherein
the document data are associated with accompanying information used for determining whether or not protection is needed, and
the deleting comprises deleting document data determined to require protection is by the accompanying information selected from the document data stored in the storage unit.

16. The computer data signal according to claim 13, further comprising:
if the printer is in the process of printing document data on a print media when the monitoring detects that the printer enters an anomalous condition, supplying different information to the printer such that different information from the document data used in the process of printing is printed on the print medium.
